(19) United States
(12) Patent Application Publication
(10) Pub. No.: US 2020/0070222 A1
(43) Pub. Date: Mar. 5, 2020

(54) Air Circulation Type of Easily Dried Intelligent Household Stuffed Toy Cleaning Machine

(71) Applicant: Wan Sze HUI, Hong Kong (HK)

(72) Inventor: Wan Sze HUI, Hong Kong (HK)

(21) Appl. No.: 16/207,086

(22) Filed: Nov. 30, 2018

(30) Foreign Application Priority Data
Aug. 30, 2018 (CN) 201811004544.X

(51) Int. Cl. B08B 11/02; A63H 3/36; B08B 5/02; B24C 3/32; B24C 9/00

(52) U.S. Cl. CPC B08B 11/02; A63H 3/36; A63H 3/02; B24C 3/32; B24C 9/003; B08B 5/02

(57) ABSTRACT

The invention relates to an air circulation type of easily dried intelligent household stuffed toy cleaning machine which includes a cleaning main body and a drawing bracket. The cleaning main body includes an outer casing, an inner casing, a sand blowing device, a sand removing device, a dehumidifying device, a controller and a guiding plate. The drawing bracket includes a door panel and a support frame having a C-shaped structure. The support frame extends into the inner casing. The door panel abuts the outer casing and the door panel and the inner casing enclose to form a closed inner cavity with annular inner wall. The support frame is further provided with a vibration motor, an extension clamp, and a vibration rod. The air circulation type of easily dried intelligent household stuffed toy cleaning machine has a simple and reasonable structure, easy to use, high degree of intelligence, has ability of thorough cleaning, and reduce damage against stuffed toys, which effectively solves the problem that stuffed toys are difficult to be cleaned.

### FIELD OF THE INVENTION

The invention relates to intelligent household equipment. In particular, the invention relates to an air circulation type of easily dried intelligent household stuffed toy cleaning machine.

### BACKGROUND

It is known that stuffed toys are popular among people. It is cute in shape, soft in material and not easy to harm people. Further, it is durable and resistant to squeezing for a long time, especially as a children's toy. When placed or played for a long time, the stuffed toys tend to stick to dirt such as dust and bacteria, so the stuffed toys must be cleaned regularly. The stuffing of the stuffed toys itself is not easy to dry, and the stuffed toys are easily deformed or even damaged after being washed. When sand-like material such as salt is used to clean the toys, the sand-like material is difficult to enter and clean the root of fluff due to the thick fluff of the stuffed toys. The cleaning is not thorough and it is very troublesome to clean.

### SUMMARY OF THE INVENTION

The technical problem to be solved is to overcome the above-mentioned deficiency by providing an air circulation type of easily dried intelligent household stuffed toy cleaning machine. It has a simple and reasonable structure, easy to use, high degree of intelligence, has ability of thorough cleaning, and reduce damage against stuffed toys, which effectively solves the problem that stuffed toys are difficult to be cleaned.

The technical solution to be solved by the present invention is to provide an air circulation type of easily dried intelligent household stuffed toy cleaning machine which includes a cleaning main body and a drawing bracket. The cleaning main body includes an outer casing, an inner casing, a sand blowing device, a sand removing device, a dehumidifying device, a controller and a guiding plate. The inner casing is sleeved and fixed on the inner cavity of the outer casing. An outer cavity is provided between the outer casing and the inner casing. Openings are disposed at two ends of the inner cavity of the inner casing. The lower end of the inner casing is provided with a sand storage tank. A stencil is arranged above the sand storage tank.

The sand blowing device, the sand removing device and the controller are disposed in the outer cavity. The sand blowing device includes a first air pump and a sand blowing pipe. An outlet of the first air pump and the sand storage tank are respectively connected with one end of the sand blowing pipe. The other end of the sand blowing pipe is connected to the opening of the inner casing. The guiding plate is hingedly disposed on the opening. The guiding plate is a V-shaped structure, and the guiding plate is inlaid with an iron block, and an electromagnet is arranged on the inner casing.

The sand removing device includes a first housing, a second air pump and a baffle. One side of the first housing is in communication with the inner cavity. The second air pump is arranged on the other side of the first housing. The baffle is vertically staggered in the inner cavity of the first housing. A pipe is arranged at the lower end of the first housing and is connected to the sand storage tank.

The dehumidifying device is inlaid on the outer casing. The dehumidifying device includes a second housing and an air duct. The second housing is connected with the inner cavity, and the middle portion of the air duct is coiled in the inner cavity of the second housing. Two ends of the air duct pass through the second housing and one end of the air duct is connected to an outlet of the third air pump at the outer cavity.

The drawing bracket includes a door panel and a support frame having a C-shaped structure. The support frame extends from another opening of the inner cavity. The door panel abuts the outer casing and the door panel and the inner casing enclose to form a closed inner cavity with annular inner wall. The support frame is further provided with a vibration motor, an extension clamp, and a vibration rod. The vibration motor and the vibration rod are mutually connected, and the extension clamp and the support frame are connected by an elastic rope.

The controller is electrically connected to the first air pump, the second air pump, the third air pump, the vibration motor, and the electromagnet, respectively.

Further, the inlet and the outlet of the first air pump and the second air pump are provided with an air filter.

Further, the sand blowing pipe is connected to the sand storage tank through the pipe, and the pipe is provided with an electromagnetic valve electrically connected to the controller to control the inflow and outflow of the cleaning sand.

Further, a plurality of far infrared heating plates are symmetrically disposed on the sidewall of the inner cavity.

Further, the inner casing is provided with a sliding rail with an inverted T-shaped structure, and the sliding rail is engaged with a chute with an inverted T-shaped structure provided on the support frame.

Further, the upper and lower ends of the second housing are respectively provided with through holes, and the through hole at the lower end is provided with a rotary plug.

The technical effect of the present invention is to provide an air circulation type of easily dried intelligent household stuffed toy cleaning machine which includes a cleaning main body and a drawing bracket. A stuffed toy is fixed on the vibration rod, and the stuffed toy is stretched out by the extension clamp. The stuffed toy is dried by far infrared heating, and the humid hot gas generated by the drying is discharged through the dehumidifying device. Under the swirling airflow or turbulent flow caused by rotation of the cleaning sand, the cleaning sand can enter the root of the fluff to thoroughly clean the stuffed toy. After the cleaning is completed, the vibration rod vibrates to shake the cleaning sand on the stuffed toy off to the sand storage tank, and find sand particles in the air are recovered into the sand storage tank by the sand removing device. The air circulation type of easily dried intelligent household stuffed toy cleaning machine has a simple and reasonable structure, easy to use, high degree of intelligence, has ability of thorough cleaning, and reduce damage against stuffed toys, which effectively solves the problem that stuffed toys are difficult to be cleaned.

### BRIEF DESCRIPTION OF THE DRAWINGS

The invention is illustrated by the following figures and embodiments.

FIG. 1 shows a schematic diagram of whole structure of an air circulation type of easily dried intelligent household stuffed toy cleaning machine in accordance with an example embodiment.

FIG. 2 shows a horizontal profile of schematic diagram of an air circulation type of easily dried intelligent household stuffed toy cleaning machine in accordance with an example embodiment.

FIG. 3 shows a longitudinal profile of schematic diagram of an air circulation type of easily dried intelligent household stuffed toy cleaning machine in accordance with an example embodiment.

FIG. 4 shows a schematic diagram of sand blowing device of an air circulation type of easily dried intelligent household stuffed toy cleaning machine in accordance with an example embodiment.

FIG. 5 shows a schematic diagram of sand removing device of an air circulation type of easily dried intelligent household stuffed toy cleaning machine in accordance with an example embodiment.

FIG. 6 shows a schematic diagram of dehumidifying device of an air circulation type of easily dried intelligent household stuffed toy cleaning machine in accordance with an example embodiment.

FIG. 7 shows a schematic diagram of guiding plate of an air circulation type of easily dried intelligent household stuffed toy cleaning machine in accordance with an example embodiment.

FIG. 8 shows a schematic diagram of drawing bracket of an air circulation type of easily dried intelligent household stuffed toy cleaning machine in accordance with an example embodiment.

The reference numbers of the figures are as follows:

1: cleaning main body; 11: outer casing; 12: inner casing; 121: electromagnet; 122: sliding rail; 123: far infra heating plate; 124: sand storage tank; 125: stencil; 13: sand blowing device; 131: first air pump; 132: air filter; 133: electromagnetic valve; 134: sand blowing pipe; 14: sand removing device; 141: first housing; 142: second air pump; 143: baffle; 15: dehumidifying device; 151: second housing; 152: rotary plug; 153: through hole; 154: air duct; 155: third air pump; 16: controller; 17: outer cavity; 18: inner cavity; 19: guiding plate; 191: iron block; 2: drawing bracket; 21: door panel; 22: support frame; 221: chute; 222: vibration motor; 223: extension clamp; 24: vibration rod.

### DETAILED DESCRIPTION

The invention is illustrated in accordance with figures. The figures as simplified diagrams demonstrate the basic structures of the apparatus of embodiments of the invention. Thus, the invention is not limited to the figures.

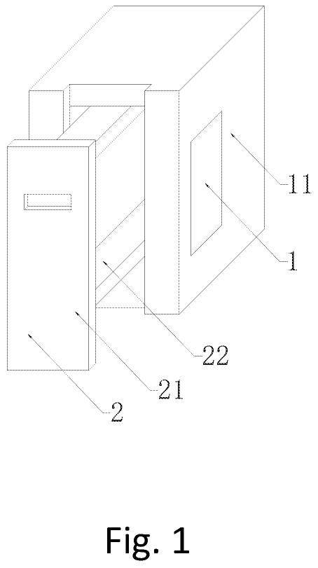

As shown in FIG. 1, an air circulation type of easily dried intelligent household stuffed toy cleaning machine includes a cleaning main body 1 and a drawing bracket 2.

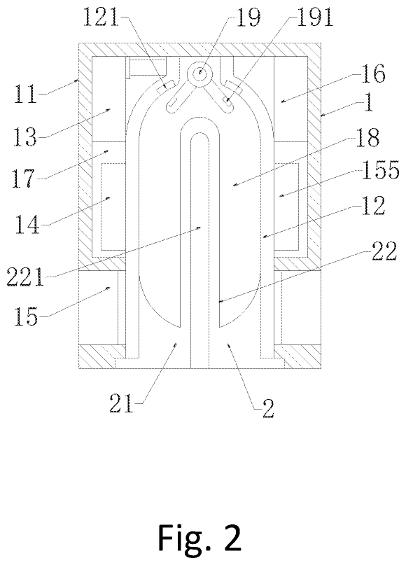

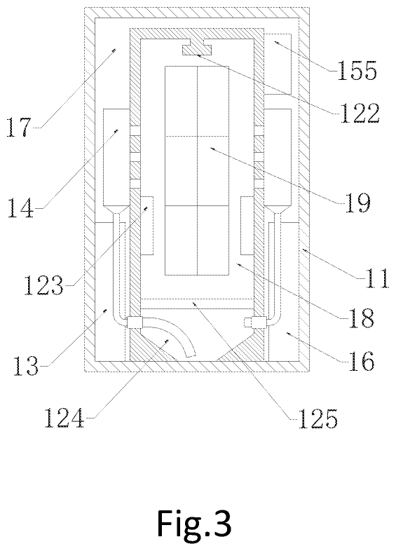

As shown in FIGS. 2 and 3, the cleaning main body 1 includes an outer casing 11, an inner casing 12, a sand blowing device 13, a sand removing device 14, a dehumidifying device 15, a controller 16 and a guiding plate 19. The inner casing 12 is sleeved and fixed on the inner cavity of the outer casing 11. The inner casing 12 is completed separated from the outer casing 11. An outer cavity 17 is provided between the outer casing 11 and the inner casing 12.

The outer casing 11 has a one-way opening. Openings are disposed at two ends of the inner cavity 18 of the inner casing 12. One of the openings is aligned with the opening of the outer casing 11. The lower end of the inner casing 12 is provided with a sand storage tank 124 which stores cleaning sand. A stencil 125 is arranged above the sand storage tank 124 to isolate the cleaning sand from the inner cavity 18.

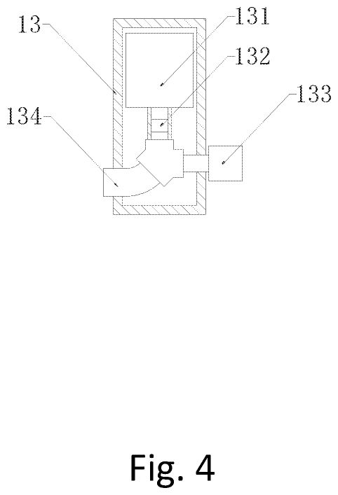

As shown in FIG. 4, the sand blowing device 13, the sand removing device 14 and the controller 16 are fixedly disposed in the outer cavity 17. The sand blowing device 13 includes a first air pump 131 and a sand blowing pipe 134. An outlet of the first air pump 131 and the sand storage tank 124 are respectively connected with one end of the sand blowing pipe 134. The first air pump 131 absorbs the air in the outer cavity 17 and then sprays it into the sand blowing pipe 134 to form a negative pressure. The cleaning sand is blown toward the inner cavity 18 under the influence of the negative pressure in the sand blowing pipe 134. In order to obtain more air, the outer casing 11 is provided with an air inlet hole.

As shown in FIG. 2, the other end of the sand blowing pipe 134 is connected to the opening at one end of the inner casing 12 which is far away from the outer chasing 11. The guiding plate 19 is hingedly disposed on the opening.

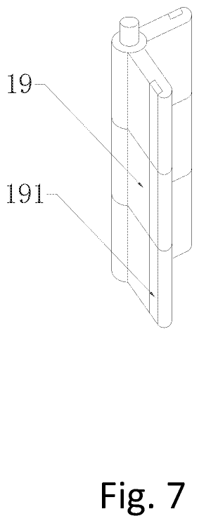

As shown in FIGS. 7 and 2, the guiding plate 19 is a V-shaped structure, and the guiding plate 19 is inlaid with an iron block 191, and an electromagnet 121 is arranged on the inner casing 12. The direction of the guiding plate 19 is changed by the attraction of the electromagnet 121 to change the direction of airflow. The airflow blows the fluff on the stuffed toy, and the cleaning sand enters the fluff to adsorb the dirt.

In an example of FIG. 3, a plurality of guiding plates 19 are vertically stacked to control the formation of turbulent flow.

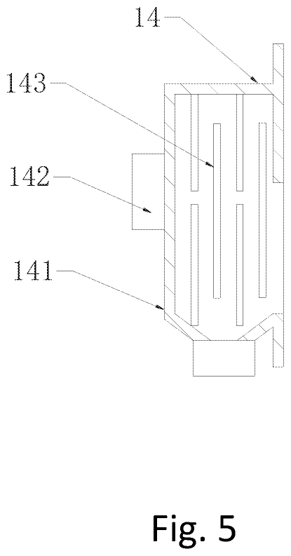

As shown in FIG. 5, the sand removing device 14 includes a first housing 141, a second air pump 142 and a baffle 143. One side of the first housing 141 is in communication with the inner cavity 18. The second air pump 142 is arranged on the other side of the first housing 141. The baffle 143 is vertically staggered in the inner cavity of the first housing 141. A pipe is arranged at the lower end of the first housing 141 and is connected to the sand storage tank 124. The second air pump 142 draws air from the first casing 141, and the airflow containing the fine cleaning sand is decelerated between the baffles 143. Sedimentation of the cleaning sand finally falls off from the pipe and goes into the sand storage tank 124 to avoid stuffed toys to be contaminated by the cleaning sand.

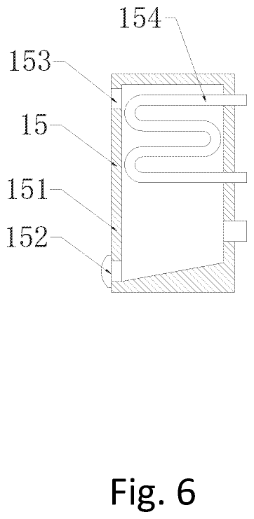

As shown in FIG. 6, the dehumidifying device 15 is inlaid on the outer casing 11. The dehumidifying device 15 includes a second housing 151 and an air duct 154. The second housing 151 is connected with the inner cavity 18, and the middle portion of the air duct 154 is coiled in the inner cavity of the second housing 151. Two ends of the air duct 154 pass through the second housing 151 and one end of the air duct 154 is connected to an outlet of the third air pump 155 at the outer cavity 17. The humid hot air enters the second housing 151. The third air pump 155 charges the cold air into the air duct 154 to condense the moisture in the hot humid air and stores it in the inner cavity of the second housing 151.

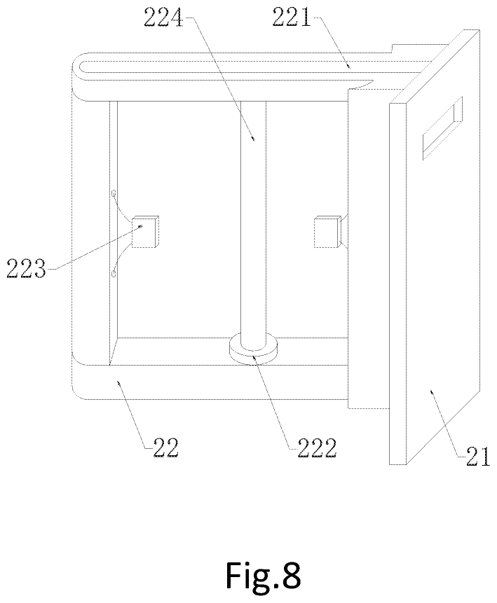

As shown in FIG. 8, the drawing bracket 2 includes a door panel 21 and a support frame 22 having a C-shaped structure. The support frame 22 extends from another opening of the inner cavity 18. The door panel 21 abuts the outer casing 11 and the door panel 21 and the inner casing 12 enclose to form a closed inner cavity 18 with annular inner wall. The annular inner wall facilitates the formation of annular airflow.

The support frame 22 is further provided with a vibration motor 222, an extension clamp 223, and a vibration rod 224. The vibration motor 222 and the vibration rod 224 are mutually connected, and the extension clamp 223 and the support frame 22 are connected by an elastic rope. The elastic rope is telescoped in the inner cavity of the support frame 22.

The controller 16 is electrically connected to the first air pump 131, the second air pump 142, the third air pump 155, the vibration motor 222, and the electromagnet 121, respectively to control their operation.

In an example as shown in FIG. 4, the inlet and the outlet of the first air pump 131 and the second air pump 142 are provided with an air filter 132 to prevent the cleaning sand entering into the air pumps.

In an example as shown in FIG. 4, the sand blowing pipe 134 is connected to the sand storage tank 124 through the pipe, and the pipe is provided with an electromagnetic valve 133 electrically connected to the controller 16 to control the inflow and outflow of the cleaning sand. After drying the stuffed toy, the electromagnetic valve 133 is opened to inject the cleaning sand to clean the stuffed toy. After cleaning is completed, when the cleaning sand needs to be removed, the electromagnetic valve 133 is closed. The cleaning sand is removed by the cooperation of the sand removing device 14 and the vibration rod 224.

In an example as shown in FIG. 3, a plurality of far infrared heating plates 123 are symmetrically disposed on the sidewall of the inner cavity. Of course, it is also possible to dry the stuffed toys using a non-contact, non-open fire heating method such as microwave heating.

In an example, the inner casing 12 is provided with a sliding rail 12 with an inverted T-shaped structure, and the sliding rail 122 is engaged with a chute 221 with an inverted T-shaped structure provided on the support frame 22.

In an example as shown in FIG. 6, the upper and lower ends of the second housing 151 are respectively provided with through holes 153, and the through hole 153 at the lower end is provided with a rotary plug 152. When the hot humid gas enters the inner cavity of the second housing 151, the condensed moisture stores in the second housing 151. The rotary plug 152 is used to block the through hole 153 for the water outlet at the lower end, and the through hole 153 at the upper end is used for releasing the pressure. In an example, the opening at upper end is provided with a pressure valve.

A air circulation type of easily dried intelligent household stuffed toy cleaning machine of the present invention has a reasonable structure. The machines includes a cleaning main body and a drawing bracket. A stuffed toy is fixed on the vibration rod, and the stuffed toy is stretched out by the extension clamp.

The stuffed toy is dried by far infrared heating, and the humid hot gas generated by the drying is discharged through the dehumidifying device. Under the swirling airflow or turbulent flow caused by rotation of the cleaning sand, the cleaning sand can enter the root of the fluff to thoroughly clean the stuffed toy. After the cleaning is completed, the vibration rod vibrates to shake the cleaning sand on the stuffed toy off to the sand storage tank, and find sand particles in the air are recovered into the sand storage tank by the sand removing device. The air circulation type of easily dried intelligent household stuffed toy cleaning machine has a simple and reasonable structure, easy to use, high degree of intelligence, has ability of thorough cleaning, and reduce damage against stuffed toys, which effectively solves the problem that stuffed toys are difficult to be cleaned.

The exemplary embodiments of the present invention are thus fully described. Although the description referred to particular embodiments; it will be clear to one skilled in the art that the present invention may be practiced with variations of these specific details. Hence this invention should not be construed as limited to the embodiments set forth herein.

What is claimed is:

1. An air circulation type of easily dried intelligent household stuffed toy cleaning machine, comprising: a cleaning main body 1 and a drawing bracket 2, wherein the cleaning main body 1 includes an outer casing 11, an inner casing 12, a sand blowing device 13, a sand removing device 14, a dehumidifying device 15, a controller 16 and a guiding plate 19; the inner casing 12 is sleeved and fixed on the inner cavity of the outer casing 11; an outer cavity 17 is provided between the outer casing 11 and the inner casing 12; openings are disposed at two ends of the inner cavity 18 of the inner casing 12; the lower end of the inner casing 12 is provided with a sand storage tank 124; a stencil 125 is arranged above the sand storage tank 124,
wherein the sand blowing device 13, the sand removing device 14 and the controller 16 are disposed in the outer cavity 17; the sand blowing device 13 includes a first air pump 131 and a sand blowing pipe 134; an outlet of the first air pump 131 and the sand storage tank 124 are respectively connected with one end of the sand blowing pipe 134; the other end of the sand blowing pipe 134 is connected to the opening at one end of the inner casing 12; the guiding plate 19 is hingedly disposed on the opening; the guiding plate 19 is a V-shaped structure, and the guiding plate 19 is inlaid with an iron block 191, and an electromagnet 121 is arranged on the inner casing 12,
wherein the sand removing device 14 includes a first housing 141, a second air pump 142 and a baffle 143; one side of the first housing 141 is in communication with the inner cavity 18; the second air pump 142 is arranged on the other side of the first housing 141; the baffle 143 is vertically staggered in the inner cavity of the first housing 141; a pipe is arranged at the lower end of the first housing 141 and is connected to the sand storage tank 124,
wherein the dehumidifying device 15 is inlaid on the outer casing 11; the dehumidifying device 15 includes a second housing 151 and an air duct 154; the second housing 151 is connected with the inner cavity 18, and the middle portion of the air duct 154 is coiled in the inner cavity of the second housing 151; two ends of the air duct 154 pass through the second housing 151 and one end of the air duct 154 is connected to an outlet of the third air pump 155 at the outer cavity 17,
wherein the drawing bracket 2 includes a door panel 21 and a support frame 22 having a C-shaped structure; the support frame 22 extends from another opening of the inner cavity 18; the door panel 21 abuts the outer casing 11 and the door panel 21 and the inner casing 12 enclose to form a closed inner cavity 18 with annular inner wall; the support frame 22 is further provided with a vibration motor 222, an extension clamp 223, and a vibration rod 224; the vibration motor 222 and the vibration rod 224 are mutually connected, and the extension clamp 223 and the support frame 22 are connected by an elastic rope,
wherein the controller 16 is electrically connected to the first air pump 131, the second air pump 142, the third air pump 155, the vibration motor 222, and the electromagnet 121, respectively.

2. The air circulation type of easily dried intelligent household stuffed toy cleaning machine of claim 1, wherein the inlet and the outlet of the first air pump 131 and the second air pump 142 are provided with an air filter 132.

3. The air circulation type of easily dried intelligent household stuffed toy cleaning machine of claim 1, wherein the sand blowing pipe 134 is connected to the sand storage tank 124 through the pipe, and the pipe is provided with an electromagnetic valve 133 electrically connected to the controller 16 to control the inflow and outflow of the cleaning sand.

4. The air circulation type of easily dried intelligent household stuffed toy cleaning machine of claim 1, wherein a plurality of far infrared heating plates 123 are symmetrically disposed on the sidewall of the inner cavity 18.

5. The air circulation type of easily dried intelligent household stuffed toy cleaning machine of claim 1, wherein the inner casing 12 is provided with a sliding rail 12 with an inverted T-shaped structure, and the sliding rail 122 is engaged with a chute 221 with an inverted T-shaped structure provided on the support frame 22.

6. The air circulation type of easily dried intelligent household stuffed toy cleaning machine of claim 1, wherein the upper and lower ends of the second housing 151 are respectively provided with through holes 153, and the through hole 153 at the lower end is provided with a rotary plug 152.
